(19) United States
(12) Patent Application Publication
(10) Pub. No.: US 2026/0120988 A1
(43) Pub. Date: Apr. 30, 2026

(54) PROTECTIVE ELEMENT AND METHOD FOR MANUFACTURING PROTECTIVE ELEMENT

(71) Applicant: DEXERIALS CORPORATION, Shimotsuke-shi, Tochigi (JP)

(72) Inventors: Masami Kawazu, Shimotsuke-shi, Tochigi (JP); Masahiro Kobo, Shimotsuke-shi, Tochigi (JP)

(73) Assignee: DEXERIALS CORPORATION, Shimotsuke-shi, Tochigi (JP)

(21) Appl. No.: 19/118,480

(22) PCT Filed: Sep. 11, 2023
(86) PCT No.: PCT/JP2023/033056

§ 371 Date: Apr. 4, 2025

(30) Foreign Application Priority Data
Oct. 12, 2022 (JP) 2022-164359

(51) Int. Cl. H01H 85/055; H01H 85/00; H01H 85/143; H01H 85/165

(52) U.S. Cl. CPC H01H 85/055; H01H 85/0047; H01H 85/143; H01H 85/165

(57) ABSTRACT

A protective element includes: an insulating substrate; a heating element provided on a front surface side of the insulating substrate; an insulating layer covering the heating element; an intermediate electrode provided on the insulating layer; a fuse element mounted on the intermediate electrode; a cap member covering the front surface of the insulating substrate; and a flux. The cap member includes at least one protrusion that retains the flux and is provided facing the intermediate electrode. At least one end portion of the intermediate electrode extends beyond the fuse element. The at least one protrusion is provided at a position facing the fuse element which is mounted on the intermediate electrode and at a position facing the at least one end portion of the intermediate electrode at which the fuse element is not mounted, and retains the flux on the fuse element and at the end portion.

### TECHNICAL FIELD

The present art relates to a protective element that is installed on a current path and cuts off the current path by fusing a fuse element when heated by a heating element. The present application claims priority to Japanese Patent Application No. 2022-164359, which was filed in Japan on Oct. 12, 2022, the contents of which are incorporated herein by reference.

### BACKGROUND ART

Lithium ion rechargeable batteries are batteries having high output and high energy density, and are used in small mobile devices such as notebook computers, mobile phones, and smart phones, and in recent years, their use in devices that require large currents and high voltages having large capacity, such as power tools, electric bicycles, electric motorcycles, electric automobiles, and home storage batteries, is progressing.

However, these batteries use organic solvents and there is a risk of fire or smoke when the operating range of the battery body temperature, input/output current, charging voltage, or the like is exceeded, and therefore, protective circuits and protective elements using electronic circuits are generally incorporated. In protective circuits, FETs for electrically turning on and off, thermistors for detecting temperature, and fuses for physically cutting a circuit are used as protective elements, and fuses having a heating element are often used for fuses.

A protective element having a fuse with a heating element, similar to a general current fuse, has a function of cutting at an overcurrent, but in addition, is able to melt and cut a fuse element by the heating element generating heat when the electronic circuit detects an abnormality. Compared to a general current fuse, which blows only at an overcurrent, this protective element has an advantage in that it blows quickly in the event of an abnormality, that a safety margin that takes into account battery characteristics, conditions of use, and the like may be easily set in the circuit, and that the fuse element can be melted and cut at an intended timing.

FIG. 21 is a diagram illustrating one configuration example of a front surface installation type protective element, wherein (A) is a plan view illustrated omitting a cap member, (B) is a cross-sectional view, and (C) is a bottom view. A protective element 100 illustrated in FIG. 21 is provided with an insulating substrate 101, first and second electrodes 102, 103 formed on a front surface of the insulating substrate 101, a heating element 104 formed on a surface of the insulating substrate 101, an insulating layer 105 covering the heating element 104, an intermediate electrode 106 laminated on the insulating layer 105 and connected to the heating element 104, a fuse element 107, being a fusible conductor mounted across the first electrode 102, the intermediate electrode 106, and the second electrode 103 via a connecting material 110 made of various tin-based solder pastes, and a flux 111 coating the fuse element 107.

The first and second electrodes 102, 103 are terminal parts connected on a current path of an external circuit to which the protective element 100 is connected, and are respectively connected via castellations to first and second external connection electrodes 102a, 103a formed on a rear surface of the insulating substrate 101. In the protective element 100, the first and second external connection electrodes 102a, 103a are connected to connection electrodes provided on an external circuit board on which the protective element 100 is installed, whereby the fuse element 107 is incorporated into a portion of a current path formed on the external circuit board.

The heating element 104 is a member having conductivity that generates heat when energized at a relatively high resistance, and is made of, for example, nichrome, W, Mo, Ru, or the like, or a material containing these. Moreover, the heating element 104 is connected to a heating element electrode 108 formed on the front surface of the insulating substrate 101. The heating element electrode 108 is connected via a castellation to a third external connection electrode 108a formed on the rear surface of the insulating substrate 101. In the protective element 100, the third external connection electrode 108a is connected to a connection electrode provided on an external circuit board on which the protective element 100 is installed, whereby the heating element 104 is connected to an external power source provided on the external circuit. In the heating element 104, energization is constantly controlled by a switching element or the like (not illustrated).

The heating element 104 is covered by the insulating layer 105 made of a glass layer or the like, and the intermediate electrode 106 is formed on the insulating layer 105, and is thereby overlapped with the intermediate electrode 106 via the insulating layer 105. Furthermore, the fuse element 107 connected across the first and second electrodes 102, 103 is connected on the intermediate electrode 106 via the connecting material 110.

Thus, in the protective element 100, the heating element 104 and the fuse element 107 are thermally connected by being overlapped, and when the heating element 104 generates heat by energization, the fuse element 107 may be fused.

The fuse element 107 is connected from the first electrode 102 through the intermediate electrode 106 to the second electrode 103, thereby configuring a part of the current path of the external circuit in which the protective element 100 is incorporated. Then, the fuse element 107 fuses due to self-heating (Joule heat) by the passage of a current exceeding the rated current. Alternatively, the fuse element 107 melts due to heat generated by the heating element 104, and fuses by the molten conductor agglomerating on the first and second electrodes 102, 103 and the intermediate electrode 106. Thus, the first and second electrodes 102, 103 are cut off from each other.

### PRIOR ART DOCUMENTS

### Patent Documents

Patent Document 1: JP 5072796
Patent Document 2: JP 5876346

### SUMMARY OF INVENTION

### Problem to be Solved by Invention

In recent years, as the applications in which lithium ion rechargeable batteries are mounted have expanded, these batteries are also beginning to be adopted in large-capacity, high-current, and high-voltage devices. For this reason, protective elements are also required to have higher ratings and higher voltages. In order to increase the rated current, a common method for decreasing the resistance of the fuse element itself is to increase a cross-sectional area of the fuse element.

However, although the resistance value of the fuse is lowered by increasing the cross-sectional area of the fuse element, the fusing operation of the fuse element by heating the heating element is affected. That is, in the fusing operation of the fuse element by heating the heating element, the fuse element is fused by the melted fuse element wetting and spreading, then agglomerating on the intermediate electrode. However, when the cross-sectional area of the fuse element is increased, the fuse element melted by heating the heating element may not be able to be contained on the electrode and may overflow, making it impossible to cut off the current path.

Therefore, an object of the present art is to provide a protective element that can be fused quickly and reliably by appropriately providing a flux even when the cross-sectional area of the fuse element is increased.

### Means for Solving Problem

When observing a sample of a protective element in which the current path can not be cut off, it was found that there was a portion to which the melted fuse element had not wet and spread to the intermediate electrode. This portion did not have a fuse element mounted and was also not coated with the flux. Reasons why a fuse element does not wet and spread include that the flux was not retained, causing oxidation of the melted fuse element to progress, and fluidity and wettability to deteriorate, and that this portion of the intermediate electrode was not covered by the flux, causing wetting to no longer occur due to deterioration (oxidation, sulfidation, and the like) of the electrode.

The inventors of the present application have discovered that by retaining the flux in a portion to which the fuse element does not conventionally wet and spread, the area over which the melted fuse element wets and spreads is increased, enabling even a fuse element having an enlarged cross-sectional area to reliably cut off current.

That is, in order to solve the above-mentioned problems, the protective element of the present art has an insulating substrate, a heating element provided on a front surface side of the insulating substrate, an insulating layer covering the heating element, an intermediate electrode provided on the insulating layer, a fuse element mounted on the intermediate electrode, a cap member covering the front surface of the insulating substrate, and a flux, wherein the cap member has a protrusion that retains the flux in a predetermined position and is provided vertically, facing the intermediate electrode, the intermediate electrode has a length that is longer than a width of the fuse element in a direction orthogonal to the current flow direction of the fuse element, and at least one end portion thereof protrudes beyond the fuse element, and the protrusion is provided at a position facing the position of the intermediate electrode at which the fuse element is mounted and at a position facing the end portion at which the fuse element is not mounted, and retains the flux on the fuse element and at the end portion.

Furthermore, the protective element of the present art has an insulating substrate, an intermediate electrode provided on a front surface side of the insulating substrate, a fuse element mounted on the intermediate electrode, a cap member covering the front surface of the insulating substrate, a flux, a heating element provided on a rear surface side opposite the front surface of the insulating substrate, and an insulating layer covering the heating element, wherein the cap member has a protrusion that retains the flux in a predetermined position and is provided vertically, facing the intermediate electrode, the intermediate electrode has a length that is longer than a width of the fuse element in a direction orthogonal to the current flow direction of the fuse element, and at least one end portion thereof protrudes beyond the fuse element, and the protrusion is provided at a position facing the position of the intermediate electrode at which the fuse element is mounted and at a position opposite the end portion at which the fuse element is not mounted, and retains the flux on the fuse element and at the end portion.

Furthermore, a method of manufacturing the protective element of the present art has a step of forming a connecting body having an insulating substrate, a heating element provided on a front surface side of the insulating substrate, an insulating layer covering the heating element, and an intermediate electrode provided on the insulating layer, a fuse element being mounted on the intermediate electrode, a step of coating the fuse element and the intermediate electrode with a flux via a mask having an opening corresponding to a coating region, and a step of connecting a cap member to the front surface of the insulating substrate on which the fuse element is mounted and covering the substrate front surface, wherein the cap member has a protrusion that retains the flux in a predetermined position and is provided vertically, facing the intermediate electrode, the intermediate electrode has a length that is longer than a width of the fuse element in a direction orthogonal to the current flow direction of the fuse element, and at least one end portion thereof protrudes beyond the fuse element, and the protrusion is provided at a position facing the position of the intermediate electrode at which the fuse element is mounted and at a position facing the end portion at which the fuse element is not mounted, and retains the flux on the fuse element and at the end portion.

Furthermore, a method of manufacturing the protective element of the present art has a step of forming a connecting body having an insulating substrate, an intermediate electrode provided on a front surface side of the insulating substrate, a heating element provided on a rear surface side opposite the front surface of the insulating substrate, and an insulating layer covering the heating element, a fuse element being mounted on the intermediate electrode, a step of coating the fuse element and the intermediate electrode with a flux via a mask having an opening corresponding to a coating region, and a step of connecting a cap member to the front surface of the insulating substrate on which the fuse element is mounted and covering the substrate front surface, wherein the cap member has a protrusion that retains the flux in a predetermined position and is provided vertically, facing the intermediate electrode, the intermediate electrode has a length that is longer than a width of the fuse element in a direction orthogonal to the current flow direction of the fuse element, and at least one end portion thereof protrudes beyond the fuse element, and the protrusion is provided at a position facing the position of the intermediate electrode at which the fuse element is mounted and at a position facing the end portion at which the fuse element is not mounted, and retains the flux on the fuse element and at the end portion.

### Effect of Invention

According to the present art, it is possible to provide a protective element that can fuse quickly and reliably even when in a fuse element having an enlarged cross-sectional area.

### BRIEF DESCRIPTION OF THE DRAWINGS

FIG. 1 is a diagram illustrating one configuration example of a protective element in which a heating element is provided on an insulating substrate front surface, wherein (A) is a plan view illustrated omitting a cap member, (B) is an A-A cross-sectional view, and (C) is a B-B cross-sectional view.

FIG. 2 is a diagram illustrating a state of the protective element illustrated in FIG. 1 in which the fuse element is fused, wherein (A) is a plan view illustrated omitting a cap member, and (B) is a B-B cross-sectional view.

FIG. 3 is a diagram illustrating a protective element in which end portion protrusions are provided vertically so as to span a position facing a position of the intermediate electrode at which the fuse element is mounted and both end portions at which the fuse element is not mounted, wherein (A) is a plan view illustrated omitting the cap member, and (B) is an A-A cross-sectional view.

FIG. 4 is a diagram illustrating a configuration in which the end portion protrusion are formed to have a smaller diameter than an intermediate protrusion, wherein (A) is a plan view illustrated omitting the cap member, and (B) is an A-A cross-sectional view.

FIG. 5 is a diagram illustrating a configuration in which an end portion protrusion faces an end portion of the intermediate electrode and partially protrudes from the end portion of the intermediate electrode, wherein (A) is a plan view illustrated omitting the cap member, and (B) is an A-A cross-sectional view.

FIG. 6 is a cross-sectional view of a fusible conductor.

FIG. 7 is a cross-sectional view illustrating manufacturing steps of the protective element, wherein (A) illustrates a step of providing a flux, (B) illustrates a connecting body to which the flux has been provided, and (C) illustrates the protective element.

FIG. 8 is a circuit diagram illustrating a configuration example of a battery pack.

FIG. 9 is a circuit diagram of the protective element.

FIG. 10 is a cross-sectional view illustrating a configuration in which a length of an end portion protrusion is longer than a length of the intermediate protrusion.

FIG. 11 is a diagram illustrating a state in which uneven distribution of flux has occurred inside the protective element, wherein (A) is a plan view illustrated omitting the cap member, and (B) is an A-A cross-sectional view.

FIG. 12 is a cross-sectional view illustrating a state in which molten conductor of the fuse element is agglomerated on the intermediate electrode.

FIG. 13 is a diagram illustrating a configuration in which a length of the end portion protrusion is longer than the length of the intermediate protrusion, and the end portion protrusion is formed to have a smaller diameter than an intermediate protrusion, wherein (A) is a plan view illustrated omitting the cap member, and (B) is an A-A cross-sectional view.

FIG. 14 is a diagram illustrating a configuration in which the length of the end portion protrusion is longer than the length of the intermediate protrusion, and the end portion protrusions are provided vertically so as to span a position facing a position of the intermediate electrode at which the fuse element is mounted and both end portions at which the fuse element is not mounted, wherein (A) is a plan view illustrated omitting the cap member, and (B) is an A-A cross-sectional view.

FIG. 15 is a diagram illustrating a configuration in which the length of the end portion protrusion is longer than the length of the intermediate protrusion, and a portion protrudes from the end portion of the intermediate electrode, wherein (A) is a plan view illustrated omitting the cap member, and (B) is an A-A cross-sectional view.

FIG. 16 is a diagram illustrating a protective element according to a variation, wherein (A) is a plan view illustrated omitting the cap member, and (B) is an A-A cross-sectional view.

FIG. 17 is a circuit diagram of the protective element according to the variation.

FIG. 18 is a diagram illustrating one configuration example of a protective element in which a heating element is provided on an insulating substrate rear surface, wherein (A) is a plan view illustrated omitting a cap member, (B) is an A-A cross-sectional view, (C) is a B-B cross-sectional view, and (D) is a bottom surface diagram.

FIG. 19 is a diagram illustrating a state of the protective element illustrated in FIG. 18 in which the fuse element is fused, omitting a cap member.

FIG. 20 is a diagram illustrating a protective element according to comparative example 1, wherein (A) is a plan view illustrated omitting the cap member, and (B) is an A-A cross-sectional view.

FIG. 21 is a diagram illustrating one configuration example of a front surface installation type protective element, wherein (A) is a plan view illustrated omitting a cap member, (B) is a cross-sectional view, and (C) is a bottom view.

### EMBODIMENTS OF INVENTION

Hereinafter, a protective element to which the present art is applied will be described in detail with reference to the drawings. Note that the present art is not limited to only the embodiments below, and various changes are of course possible within a scope that does not depart from the spirit of the present art. In addition, the drawings are schematic and the ratios of dimensions may differ from the actual ones. Specific dimensions and the like should be determined in consideration of the following description. Furthermore, parts are of course included in which the dimensional relationships and ratios differ between drawings.

### First Embodiment

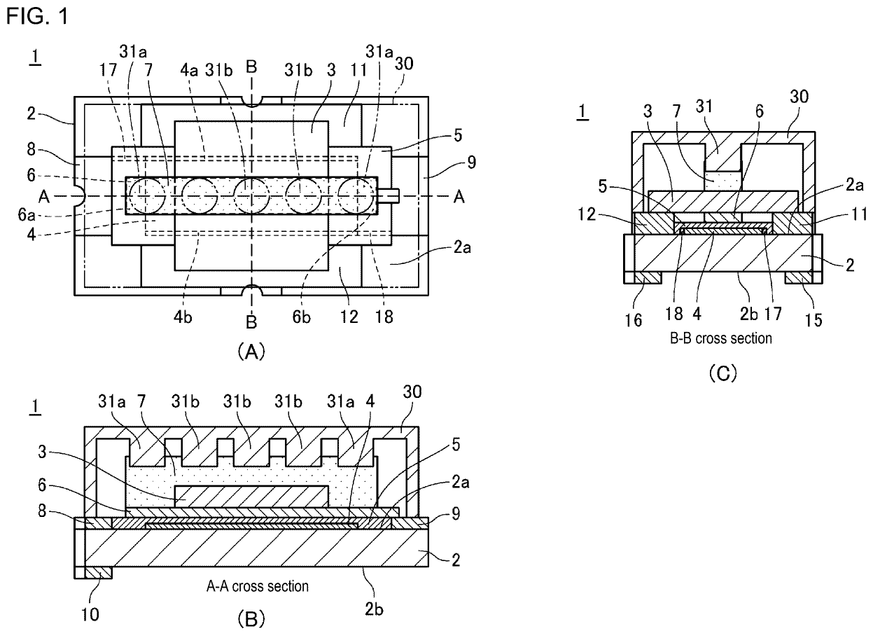

As illustrated in FIG. 1(A) to (C), a protective element 1 to which the present art is applied has an insulating substrate 2, a heating element 4 provided on a front surface 2a side of the insulating substrate 2, an insulating layer 5 covering the heating element 4, an intermediate electrode 6 provided on the insulating layer 5, a fuse element 3 mounted on the intermediate electrode 6, a cap member 30 covering the front surface 2a of the insulating substrate 2, and a flux 7.

The cap member 30 has a protrusion 31 that retains the flux 7 at a predetermined position provided vertically, facing the intermediate electrode 6. The intermediate electrode 6 has a length longer than a width of the fuse element 3 in a direction orthogonal to the current flow direction of the fuse element 3, and at least one of end portions 6a, 6b, preferably both of the end portions 6a, 6b, protrude beyond the fuse element 3.

The protrusion 31 is provided at positions of the intermediate electrode 6 facing the position at which the fuse element 3 is mounted and at positions facing the end portion 6a and the end portion 6b at which the fuse element 3 is not mounted, and retains the flux 7 on the fuse element 3 and on the end portion 6a and end portion 6b.

Thus, the protective element 1 is able to retain the flux 7 even on a portion of the intermediate electrode 6 at which the fuse element 3 is not mounted, and since an area at which the melted fuse element 3 wets and spreads increases, is able to quickly and reliably fuse even when the cross-sectional area of the fuse element 3 is increased.

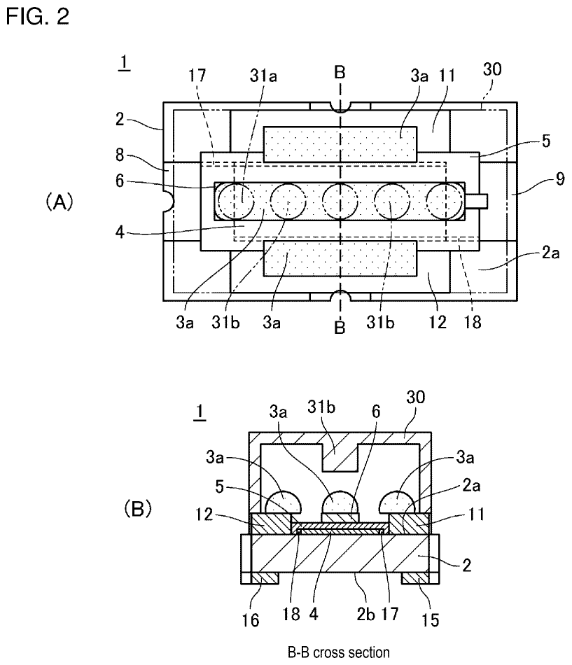

In such a protective element 1, by being incorporated in an external circuit such as a protective circuit of a lithium ion rechargeable battery, the fuse element 3 configures a part of a current path of the external circuit, and the current path is cut off by fusing due to heat generation of the heating element 4 or an overcurrent exceeding the rated value (see FIG. 2). Various configurations of the protective element 1 will be described in detail below.

### [Insulating Substrate]

The insulating substrate 2 is configured by an insulating member such as alumina, glass ceramic, mullite, or zirconia. Alternatively, a material used for printed circuit boards, such as a glass epoxy substrate or a phenol substrate may be used for the insulating substrate 2. Note that in the present specification, the surface of the insulating substrate 2 on which the fuse element 3 is mounted is the front surface 2a, and the surface on the opposite side of the surface on which the fuse element 3 is mounted is a rear surface 2b.

### [First and Second Electrodes]

A first electrode 11 and a second electrode 12 are formed on both opposite end portions of the front surface 2a of the insulating substrate 2. The first electrode 11 and the second electrode 12 are each formed by a conductive pattern of Ag, Cu, an alloy thereof, or the like. The first electrode 11 and the second electrode 12 may be formed, for example, by printing an Ag paste in a predetermined pattern by screen printing, and then firing at a predetermined temperature.

The first electrode 11 is continuous from the front surface 2a of the insulating substrate 2 to a first external connection electrode 15 formed on the rear surface 2b via castellation. Furthermore, the second electrode 12 is continuous from the front surface 2a of the insulating substrate 2 to a second external connection electrode 16 formed on the rear surface 2b via castellation. In a front surface installation type protective element 1, when the protective element 1 is installed on an external circuit board, first and second external connection electrodes 15, 16 are connected to connection electrodes provided on the external circuit board, whereby the fuse element 3 is incorporated in a part of a current path formed on the external circuit board.

The first and second electrodes 11, 12 are electrically connected via the fuse element 3 by mounting the fuse element 3 via various tin-based solder pastes or other conductive connecting materials. Furthermore, as illustrated in FIG. 2, connection between the first and second electrodes 11, 12 is cut off when the heating element 4 generates heat when energized and the fuse element 3 fuses, or when a large current exceeding the rated value flows through the protective element 1 and the fuse element 3 fuses due to self-heating (Joule heat).

### [Heating Element]

The heating element 4 is a member having conductivity that generates heat when energized at a relatively high resistance, and is made of, for example, nichrome, W, Mo, Ru, or the like, or a material containing these. The heating element 4 may be formed by mixing a powder of an alloy, composition, or compound of these with a resin binder or the like to form a paste, forming a pattern on the insulating substrate 2 using a screen printing technique, and then firing, or the like. As an example, the heating element 4 may be formed by adjusting a mixed paste of a ruthenium oxide-based paste, silver, and a glass paste according to a predetermined voltage, forming a film of a predetermined area at a predetermined position on the front surface 2a of the insulating substrate 2, and then performing a firing process under appropriate conditions. A shape of the heating element 4 may be designed as appropriate, but it is preferably substantially rectangular in accordance with the shape of the insulating substrate 2 as illustrated in FIG. 1 so that heating area may be maximized.

Furthermore, the heating element 4 has one end portion 4a connected to a first extraction electrode 17 and another end portion 4b connected to a second extraction electrode 18. The first extraction electrode 17 is extracted from a first heating element electrode 8 formed on one side edge of the front surface 2a of the insulating substrate 2. The second extraction electrode 18 is extracted from a second heating element electrode 9 formed on another side edge of the front surface 2a of the insulating substrate 2. The first extraction electrode 17 is extracted from the first heating element electrode 8 along the one end portion 4a of the heating element 4, and in the protective element 1 illustrated in FIG. 1, extends along the one side edge of the heating element 4 formed in a substantially rectangular shape, and overlaps the one side edge of the heating element 4. Similarly, the second extraction electrode 18 is extracted along the other end portion 4b of the heating element 4 from the second heating element electrode 9, and in the protective element 1 illustrated in FIG. 1, extends along the other side edge of the heating element 4 formed in a substantially rectangular shape, and overlaps the other side edge of the heating element 4.

### [Insulating Layer]

Furthermore, the heating element 4, the first extraction electrode 17 and the second extraction electrode 18 are covered by the insulating layer 5. Furthermore, the intermediate electrode 6 is formed on the insulating layer 5.

The insulating layer 5 serves to protect and insulate the heating element 4. In order to efficiently transfer heat of the heating element 4 to the intermediate electrode 6 and the fuse element 3, the insulating layer 5 is formed to be thin, for example, 10 to 40 μm in thickness. The insulating layer 5 may be formed, for example, by applying and firing a glass-based paste.

The first heating element electrode 8 and the second heating element electrode 9 are formed on opposing side edges of the insulating substrate 2 which are different from the side edges on which the first and second electrodes 11, 12 are provided. The first heating element electrode 8 is an electrode that serves as a power supply terminal for the heating element 4, and is connected to the one end portion 4a of the heating element 4 via the first extraction electrode 17, and is continuous with a third external connection electrode 10 formed on the rear surface 2b of the insulating substrate 2 via castellation. The second heating element electrode 9 is connected to the other end portion 4b of the heating element 4 via the second extraction electrode 18, and is connected to the intermediate electrode 6.

The first and second heating element electrodes 8, 9, the first and second extraction electrodes 17, 18, and the intermediate electrode 6, like the first and second electrodes 11, 12, may be formed by printing and firing a conductive paste such as Ag or Cu. Furthermore, by constituting each of these electrodes formed on the front surface 2a of the insulating substrate 2 from the same material, they may be formed through one or a plurality of printing steps and firing steps.

Note that the first heating element electrode 8 may be provided with a restricting wall (not illustrated) to prevent the solder for connection provided on an electrode of the external circuit board connected to the third external connection electrode 10 from melting during reflow installation or the like, creeping up onto the first heating element electrode 8 via castellation, and wetting and spreading onto the first heating element electrode 8. Similarly, the first and second electrodes 11, 12 may also be provided with a restricting wall. The restricting wall, for example, may be formed using an insulating material that is not wettable by solder, such as glass, solder resist, or an insulating adhesive, and may be formed on the first heating element electrode 8 or the first and second electrodes 11, 12 by printing or the like. By providing the restricting wall, the melted solder for connection is prevented from wetting and spreading to the first heating element electrode 8 and the first and second electrodes 11, 12, and the connectivity between the protective element 1 and the external circuit board may be maintained.

The intermediate electrode 6 is an electrode provided across the second heating element electrode 9 onto the insulating layer 5. One end side of the intermediate electrode 6 is connected to the other end portion 4b of the heating element 4 via the second heating element electrode 9 and the second extraction electrode 18. Furthermore, the other end side of the intermediate electrode 6 extends onto the insulating layer 5 in a region between the first electrode 11 and the second electrode 12, and is overlapped on the heating element 4 via the insulating layer 5. The intermediate electrode 6 is connected to the fuse element 3 via a bonding material such as a solder for connection.

The fuse element 3 is installed across the first and second electrodes 11, 12, and fuses due to heat generated by energization of the heating element 4, or due to self-heating (Joule heat) when a current exceeding the rated value is passed, thereby cutting off the current path between the first electrode 11 and the second electrode 12. The fuse element 3 is coated with the flux 7 with an object of preventing oxidation, improving wettability, and achieving rapid fusing. The configuration of the fuse element 3 will be described in detail later.

Note that it is preferable that the front surfaces of the first and second electrodes 11, 12 and the intermediate electrode 6 are coated with a film of Ni/Au plating, Ni/Pd plating, Ni/Pd/Au plating, or the like by a known method such as plating. As a result, the protective element 1 may prevent oxidation of the first and second electrodes 11, 12 and the intermediate electrode 6, and prevent fluctuations in the rated value due to an increase in conductive resistance. Furthermore, when the protective element 1 is installed by reflow, the first and second electrodes 11, 12 and the intermediate electrode 6 may be prevented from being corroded (solder eaten) by melting of the solder for connection connecting the fuse element 3.

### [Flux]

Here, the intermediate electrode 6 of the present art, in a plan view, has a length longer than a width of the fuse element 3 in a direction orthogonal to the current flow direction of the fuse element 3, and at least one of the end portions 6a, 6b protrude beyond the fuse element 3. The flux 7 is retained on the fuse element 3 and at the end portion 6a and/or end portion 6b protruding from the fuse element 3 by the protrusions 31 of the cap member 30 described later.

The direction orthogonal to the current flow direction of the fuse element 3 is the fusing direction of the fuse element 3, and the fuse element 3 may cut off the current path between the first and second electrodes 11, 12 by fusing in this direction. At least one of the end portions 6a, 6b of the intermediate electrode 6 protrudes in that direction, and the flux 7 is retained on the fuse element 3 and at the end portion 6a and/or the end portion 6b.

This allows the protective element 1 to retain the flux 7 also at the end portion 6a and/or the end portion 6b of the intermediate electrode 6 on which the fuse element 3 is not mounted, and to prevent oxidation of the intermediate electrode 6. Therefore, since an area at which the melted fuse element 3 wets and spreads increases, the intermediate electrode 6 is able to quickly and reliably fuse even when a melting amount is increased due to the cross-sectional area of the fuse element 3 being increased. Furthermore, by quickly fusing the fuse element 3, damage to the intermediate electrode 6 and the heating element 4 itself may be prevented, and a heat generation cutoff operation may be stabilized.

Note that in order to increase an amount of the melted fuse element 3 retained by the intermediate electrode 6, as illustrated in FIG. 1, it is preferable that both end portions 6a, 6b of the intermediate electrode 6 protrude from the fuse element 3 and retain the flux 7.

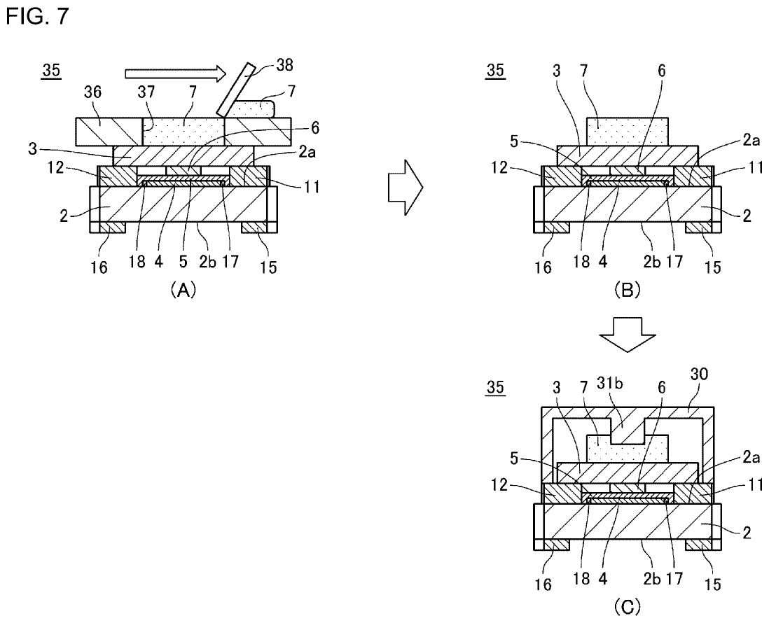

The flux 7 may be applied in a predetermined amount to a predetermined area by applying via a mask 36 having an opening 37 corresponding to a coating region (see FIG. 7). In this applying method, a mask such as a metal mask or a screen mask having an opening corresponding to the coating region of the flux 7 is prepared, and this mask is disposed around the coating region of the flux 7 and pressed using a squeegee. This allows the flux 7 to be printed in an opening region of the mask in an amount corresponding to the thickness of the mask.

### [Cap Member]

The cap member 30 is attached via an adhesive to the front surface 2a of the insulating substrate 2 on which the fuse element 3 is mounted. The cap member 30 protects an inside of the protective element 1 and prevents scattering of melted material generated when the fuse element 3 fuses. An insulating material such as various engineering plastics, ceramics, or the like may be used as a material of the cap member 30.

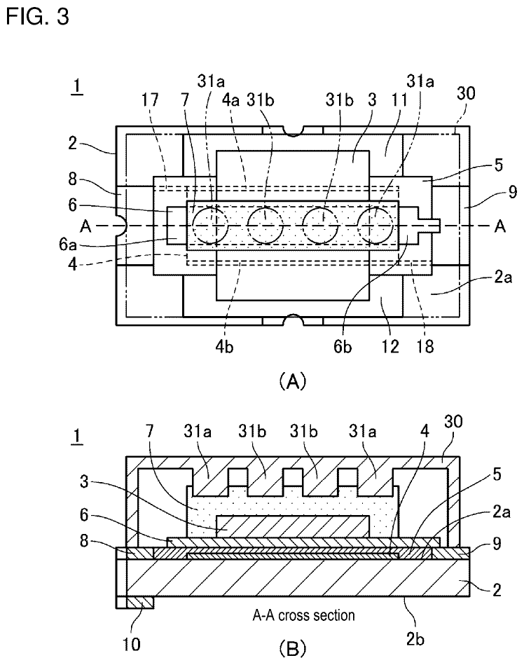

The cap member 30 has a protrusion 31 that retains the flux 7 at a predetermined position provided vertically on an inside of a ceiling surface. The protrusion 31 is provided at positions facing the position of the intermediate electrode 6 at which the fuse element 3 is mounted and at positions facing the end portion 6a and/or the end portion 6b at which the fuse element 3 is not mounted, acts as tension due to contacting the flux 7, and retains the flux 7 on the fuse element 3 and at the end portion 6a and/or end portion 6b. Note that, as illustrated in FIG. 1, the protrusion 31 may be provided vertically at a position facing the position of the intermediate electrode 6 at which the fuse element 3 is mounted and at positions facing the end portion 6a and/or end portion 6b at which the fuse element 3 is not mounted, respectively, or, as illustrated in FIG. 3, may be provided vertically so as to span both positions.

Note that in the present specification, of the plurality of vertically provided protrusions 31, a protrusion that at least partially faces the end portions 6a, 6b of the intermediate electrode 6 at which the fuse element 3 is not mounted is referred to as an end portion protrusion 31a, and a protrusions that face a position of the intermediate electrode 6 at which the fuse element 3 is mounted is referred to as an intermediate protrusion 31b.

A length of the protrusion 31 is determined according to a distance to the intermediate electrode 6 or the fuse element 3. A distance between the end portion protrusion 31a, which is provided at a position opposite the end portions 6a, 6b of the intermediate electrode 6 at which the fuse element 3 is not mounted, and the end portions 6a, 6b of the intermediate electrode 6 is set to a distance that allows the end portion protrusion 31a to contact the flux 7 and to retain the flux 7, and is set to, for example, 350 μm or less. Similarly, a distance between the intermediate protrusion 31b, which is provided at a position opposite to the position of the intermediate electrode 6 at which the fuse element 3 is mounted, and the fuse element 3 is also set to a distance that allows the intermediate protrusion 31b to contact the flux 7 and retain the flux 7, and is set to, for example, 350 μm or less.

Furthermore, it is necessary for the end portion protrusion 31a and the intermediate protrusion 31b to avoid contact with the molten conductor 3a of the fuse element 3 that agglomerates on the intermediate electrode 6. That is, when the cross-sectional area of the fuse element 3 increases, the amount of the molten conductor 3a of the fuse element 3 retained by the intermediate electrode 6 also increases. Therefore, the molten conductor 3a agglomerated on the intermediate electrode 6 may come into contact with the protrusion 31. Thus, heat from the heating element 4 is dissipated to the protrusion 31 and the cap member 30 via the molten conductor 3a, which may hinder heating and fusing of the fuse element 3. Therefore, a distance between the end portion protrusion 31a and the end portions 6a, 6b of the intermediate electrode 6 and a distance between the intermediate protrusion 31b and the fuse element 3 are distances according to a volume of the molten conductor 3a, and are each set to, for example, 100 μm or more. The end portion protrusion 31a and the intermediate protrusion 31b are provided with a length that does not come into contact with the molten conductor 3a, thereby preventing dissipation of heat from the heating element 4 due to contact with the molten conductor 3a, and enabling the fuse element 3 to be fused quickly and reliably.

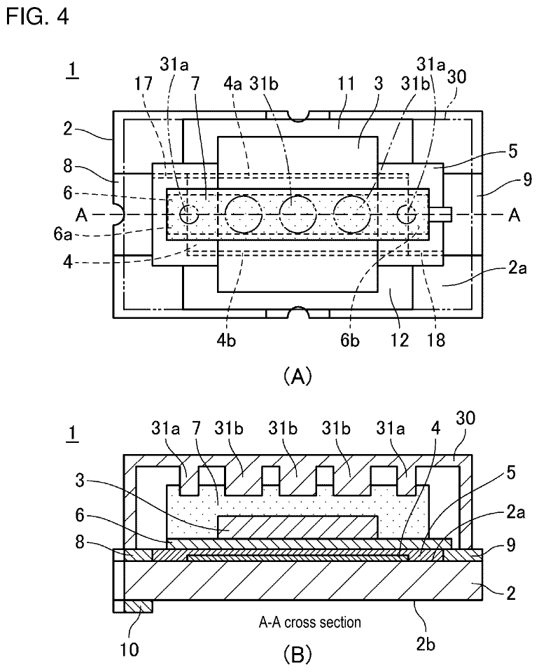

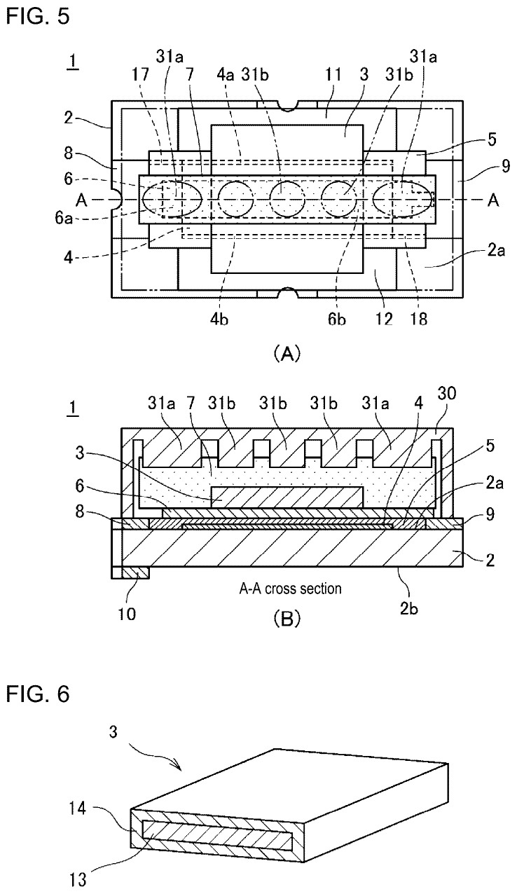

The shape of the protrusion 31 is not particularly limited, and may be, for example, a cylindrical or columnar shape. Moreover, one or a plurality of the protrusion 31 is provided. The front surface of the protrusion 31 that contacts the flux 7 may be smooth or may be textured and rough. The protrusions 31 may all be formed to have the same shape and the same size, or may be formed to have partially different shapes and sizes. For example, as illustrated in FIG. 4, the end portion protrusion 31a may be formed to have a smaller diameter than the intermediate protrusion 31b. Furthermore, as illustrated in FIG. 5, the end portion protrusion 31a may be shaped and sized to face the end portions 6a, 6b of the intermediate electrode 6 and to partially protrude from the end portions 6a, 6b. This allows the flux 7 to be held up to a position beyond the ends 6 a and 6 b of the intermediate electrode 6. In the configuration illustrated in FIG. 5, the end portion protrusion 31a is formed in an elliptical cylindrical shape having a major axis extending in the width direction (fusing direction) orthogonal to the current flow direction of the fuse element 3, but the shape of the end portion protrusion 31a is not limited to this.

The protrusions 31 are arranged above the intermediate electrode 6 along the longitudinal direction of the intermediate electrode 6. This retains the flux 7 along the region of the intermediate electrode 6 that is heated by the heating element 4. Furthermore, the arrangement pattern of the protrusions 31 is not particularly limited, and they may be arranged in a single row or in a plurality of rows. Furthermore, when arranged in a plurality of rows, the protrusions 31 may be arranged in parallel or in a staggered pattern.

Furthermore, in order to prevent the flux from being unevenly distributed, it is preferable that the protrusions 31 are arranged at regular intervals, but the intervals at which they are provided vertically do not need to be regular. For the same reason, it is preferable that the protrusions 31 are arranged symmetrically in a direction orthogonal to the current flow direction of the fuse element in a cross-sectional view, but they do not need to be symmetrical.

Note that in order to increase an amount of the melted fuse element 3 retained by the intermediate electrode 6, it is preferable that both end portions 6a, 6b of the intermediate electrode 6 protrude from the fuse element 3, the end portion protrusion 31a retains the flux 7 up to a tip end of both end portions 6a, 6b, and oxidation is prevented on the entirety of the intermediate electrode 6.

### [Fuse Element]

Next, the fuse element 3 will be described. The fuse element 3 is installed across the first and second electrodes 11, 12, and fuses due to heat generated by energization of the heating element 4, or due to self-heating (Joule heat) when a current exceeding the rated value is passed, thereby cutting off the current path between the first electrode 11 and the second electrode 12.

The fuse element 3 may be made of any conductive material that melts when heat is generated by energization of the heating element 4 or when an overcurrent occurs. For example, SnAgCu-based Pb-free solder, BiPbSn alloy, BiPb alloy, BiSn alloy, SnPb alloy, PbIn alloy, ZnAl alloy, InSn alloy, PbAgSn alloy, and the like may be used.

Furthermore, the fuse element 3 may also be a structure containing a high melting point metal and a low melting point metal. For example, as illustrated in FIG. 6, the fuse element 3 is a laminated structure having of an inner layer and an outer layer, and has a low melting point metal layer 13 as the inner layer and a high melting point metal layer 14 as the outer layer laminated on the low melting point metal layer 13. The fuse element 3 is connected onto the first and second electrodes 11, 12 and the intermediate electrode 6 via a conductive connecting material such as connecting solder.

The low melting point metal layer 13 is preferably a solder or a metal containing Sn as a main component, which is a material generally called “Pb-free solder.” The melting point of the low melting point metal layer 13 does not necessarily need to be higher than the temperature of a reflow furnace, and may melt at about 200° C. The high melting point metal layer 14 is a metal layer laminated on the surface of the low melting point metal layer 13, and is, for example, Ag or Cu, or a metal having one of these as a main component, and has a high melting point that does not melt even when the first and second electrodes 11, 12 and the intermediate electrode 6 are connected to the fuse element 3 or the protective element 1 is installed on the external circuit board by reflow.

Such a fuse element 3 may be formed by depositing a high melting point metal layer on a low melting point metal foil using a plating technique, or may be formed using other well-known lamination techniques or film formation techniques. At this time, the fuse element 3 may have a structure in which the entire surface of the low melting point metal layer 13 is covered by the high melting point metal layer 14, or may have a structure that is covered except for a pair of opposite side surfaces. The fuse element 3 may be configured with the high melting point metal layer 14 as the inner layer and the low melting point metal layer 13 as the outer layer, or may have a multi-layer structure of three or more layers in which the low melting point metal layers 13 and the high melting point metal layers 14 are alternately laminated, or an opening is provided in part of the outer layer to expose part of the inner layer.

In the fuse element 3, by laminating a high melting point metal layer 14 as an outer layer on a low melting point metal layer 13 as an inner layer, the fuse element 3 can maintain its shape and will not melt even if the reflow temperature exceeds the melting temperature of the low melting point metal layer 13. Therefore, the connection of the first and second electrodes 11, 12 and the intermediate electrode 6 to the fuse element 3 and the mounting of the protective element 1 on an external circuit board can be efficiently performed by reflow, and it is also possible to prevent fluctuations in the fusing characteristics, such as not melting at a specified temperature or melting at a temperature lower than the specified temperature, due to localized increases or decreases in resistance value accompanying deformation of the fuse element 3 even by reflow.

Furthermore, the fuse element 3 will not melt even due to self-heating while a predetermined rated current is flowing through it. When a current higher than the rated value flows, the element melts due to self-heating, and cuts off the current path between the first and second electrodes 11, 12. Furthermore, when the heating element 4 is energized and generates heat, it melts and cuts off the current path between the first and second electrodes 11, 12.

At this time, in the fuse element 3, the molten low melting point metal layer 13 corrodes (solder eats) the high melting point metal layer 14, so that the high melting point metal layer 14 melts at a temperature lower than the melting temperature. Therefore, the fuse element 3 can be blown in a short time by utilizing the erosion of the high melting point metal layer 14 by the low melting point metal layer 13. In addition, since the molten conductor 3a of the fuse element 3 is disconnected by the physical pulling action of the intermediate electrode 6 and the first and second electrodes 11, 12, the current path between the first and second electrodes 11, 12 can be quickly and reliably interrupted (FIG. 2).

In addition, it is preferable that the fuse element 3 be formed so that the volume of the low melting point metal layer 13 is greater than the volume of the high melting point metal layer 14. The fuse element 3 is heated by self-heating due to an overcurrent or by heat generated by the heating element 4, and the low melting point metal melts and corrodes the high melting point metal, thereby allowing quick melting and cutoff. Therefore, by forming the volume of the low melting point metal layer 13 to be greater than the volume of the high melting point metal layer 14, the fuse element 3 can promote this corrosion action and quickly cut off the first and second electrodes 11, 12.

In addition, since the fuse element 3 is constructed by laminating a high melting point metal layer 14 on an inner layer of a low melting point metal layer 13, the melting temperature can be significantly reduced compared to conventional chip fuses made of high melting point metals. Therefore, the fuse element 3 can have a larger cross-sectional area and a significantly improved current rating compared to a chip fuse or the like of the same size. Furthermore, it can be made smaller and thinner than conventional chip fuses having the same current rating, and has excellent fast-acting properties.

Furthermore, the fuse element 3 can improve resistance (pulse resistance) to a surge, which is an instantaneous application of an abnormally high voltage to an electric system in which the protective element 1 is incorporated. That is, the fuse element 3 must not melt even when a current of, for example, 100 A flows for several msec. In this regard, since a large current that flows in an extremely short time flows through the surface layer of the conductor (skin effect), the fuse element 3 has a high melting point metal layer 14 such as Ag plating with a low resistance value provided as an outer layer, which makes it easy to pass the current applied by a surge and prevents melting due to self-heating. Therefore, the fuse element 3 can significantly improve surge resistance compared to fuses made of conventional solder alloys.

### [Protective Element Manufacturing Process]

Next, the manufacturing process of the protective element 1 will be described. FIG. 7 is a cross-sectional view illustrating manufacturing steps of the protective element 1, wherein FIG. 7(A) illustrates a step of providing a flux, FIG. 7(B) illustrates a connecting body 35 to which the flux has been provided, and FIG. 7(C) illustrates the protective element 1. The manufacturing process of the protective element 1 includes the steps of forming a connecting body 35 having an insulating substrate 2, a heating element 4 provided on the front surface 2a of the insulating substrate 2, an insulating layer 5 covering the heating element 4, and an intermediate electrode 6 provided on the insulating layer 5, with the fuse element 3 connected to the intermediate electrode 6, applying flux 7 onto the fuse element 3 through a mask 36 having an opening corresponding to the application area, and connecting a cap member 30 to the front surface 2a of the insulating substrate 2 on which the fuse element 3 is mounted to cover the substrate surface.

As described above, the first and second electrodes 11, 12, the first and second heating element electrodes 8, 9, and the first and second extraction electrodes 17, 18 are formed on the front surface 2a of the insulating substrate 2 by printing and firing a conductive paste such as Ag or Cu using a screen printing technique or the like.

Furthermore, the heating element 4 is made from Nichrome, W, Mo, Ru, or a material containing these, and can be formed by forming a pattern on the insulating substrate 2 using screen printing technology and firing by mixing these alloys or compositions or compound powders with a resin binder or the like. On the heating element 4 and the first and second extraction electrodes 17, 18, a glass-based paste or the like is applied by using a screen printing technique or the like, and then fired to form the insulating layer 5.

Furthermore, an intermediate electrode 6 is formed from the second heating element electrode 9 onto the insulating layer 5 by printing and baking a conductive paste of Ag, Cu, or the like using a screen printing technique or the like. The first and second electrodes 11, 12 and the intermediate electrode 6 are printed with a conductive connecting material such as a connecting solder, and after the fuse element 3 is mounted, they are subjected to a reflow process. Thus, the connecting body 35 to which the fuse element 3 is connected is obtained.

Next, the flux 7 is applied onto the fuse element 3 through a mask 36 (such as a metal mask or a screen mask) having openings 37 corresponding to the application areas. In this application process, as illustrated in FIG. 7(A), in the screen printing method, a mask 36 having openings 37 corresponding to the printed portions of the flux 7 is placed around the printed portions, and a squeegee 38 slides over the front surface of the mask 36, thereby applying the flux 7 to the thickness of the mask 36 at the position and area corresponding to the openings 37 (FIG. 7(B)).

Next, a cap member 30 is connected to the front surface 2a of the insulating substrate 2 on which the fuse element 3 is mounted, to cover the substrate surface, thereby obtaining the protective element 1 (FIG. 7(C)). At this time, by providing the protrusions 31 on the cap member 30, the flux 7 in contact with the tips of the protrusions 31 is attracted by the surface tension of the flux 7, and the flux 7 can be retained in a predetermined position.

### [Circuit Configuration Example]

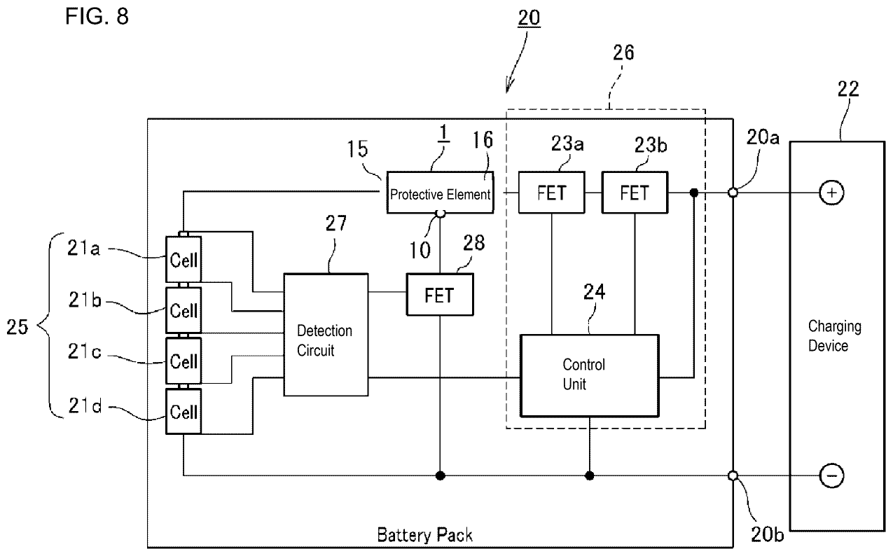

Such a protective element 1 is used by being incorporated into a circuit within a battery pack 20 of a lithium ion rechargeable battery, for example. As illustrated in FIG. 8, the battery pack 20 has a battery stack 25 made up of, for example, a total of four lithium ion rechargeable battery cells 21a to 21d.

The battery pack 20 includes a battery stack 25, a charge/discharge control circuit 26 that controls charging and discharging of the battery stack 25, a protective element 1 to which the present invention is applied that cuts off a charge/discharge path in the event of an abnormality in the battery stack 25, a detection circuit 27 that detects the voltage of each of the battery cells 21a to 21d, and a current control element 28 that serves as a switch element that controls the operation of the protective element 1 in accordance with the detection result of the detection circuit 27.

The battery stack 25 is a series connection of battery cells 21a to 21d that require control to protect against overcharge and overdischarge conditions, and is detachably connected to a charging device 22 via the positive terminal 20a and negative terminal 20b of the battery pack 20, and a charging voltage from the charging device 22 is applied. The battery pack 20 charged by the charging device 22 can operate an electronic device that is powered by a battery by connecting the positive terminal 20a and the negative terminal 20b to the electronic device.

The charge/discharge control circuit 26 includes two current control elements 23a, 23b connected in series to a current path between the battery stack 25 and the charging device 22, and a control unit 24 that controls the operation of these current control elements 23a, 23b. The current control elements 23a, 23b are, for example, configured from field effect transistors (hereinafter referred to as FETs), and by controlling the gate voltage by the control unit 24, conduction and interruption in the charging direction and/or the discharging direction of the current path of the battery stack 25 are controlled. The control unit 24 operates by receiving power supply from the charging device 22, and controls the operation of the current control elements 23a, 23b so as to cut off the current path when the battery stack 25 is overdischarged or overcharged, depending on the detection result by the detection circuit 27.

The protective element 1 is connected, for example, on a charge/discharge current path between a battery stack 25 and a charge/discharge control circuit 26, and its operation is controlled by a current control element 28.

The detection circuit 27 is connected to each of the battery cells 21a to 21d, detects the voltage value of each of the battery cells 21a to 21d, and supplies each voltage value to the control unit 24 of the charge/discharge control circuit 26. Furthermore, the detection circuit 27 outputs a control signal for controlling the current control element 28 when any one of the battery cells 21a to 21d reaches an overcharge voltage or an overdischarge voltage.

The current control element 28 is composed of, for example, a FET, and when the detection signal output from the detection circuit 27 indicates that the voltage value of the battery cells 21a to 21d exceeds a predetermined over-discharge or over-charge state, it operates the protective element 1 and controls the charge/discharge current path of the battery stack 25 to be cut off regardless of the switch operation of the current control elements 23a, 23b.

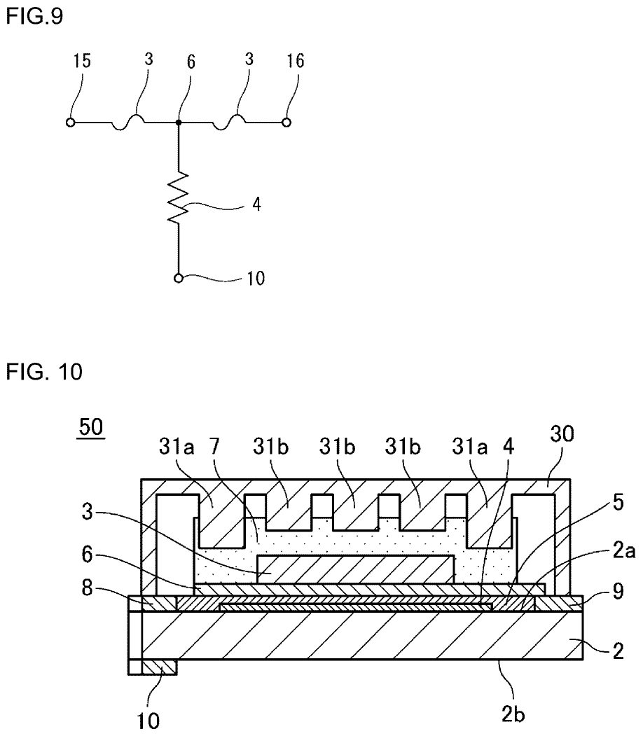

The protective element 1 to which the present invention is applied, which is used in the battery pack 20 having the above-mentioned configuration, has a circuit configuration as illustrated in FIG. 9. That is, the protective element 1 has a first external connection electrode 15 connected to the battery stack 25 side and a second external connection electrode 16 connected to the positive terminal 20a side, thereby connecting the fuse element 3 in series on the charge/discharge path of the battery stack 25. In addition, in the protective element 1, the heating element 4 is connected to the current control element 28 via the first heating element electrode 8 and the third external connection electrode 10, and the heating element 4 is connected to the battery stack 25. In this way, one end of the heating element 4 is connected to the fuse element 3 and one end of the battery stack 25 via the intermediate electrode 6, and the other end is connected to the current control element 28 and the other end of the battery stack 25 via the third external connection electrode 10. This forms a power supply path to the heating element 4, the current supply of which can be controlled by the current control element

### [Operation of Protective Element]

When the detection circuit 27 detects an abnormal voltage in any of the battery cells 21a to 21d, it outputs a cutoff signal to the current control element 28. Then, the current control element 28 controls the current so as to pass electricity through the heating element 4. In the protective element 1, a current flows from the battery stack 25 to the heating element 4, which causes the heating element 4 to start generating heat. In the protective element 1, the fuse element 3 melts due to heat generated by the heating element 4, thereby cutting off the charge/discharge path of the battery stack 25. In addition, by forming the fuse element 3 of the protective element 1 so that it contains a high melting point metal and a low melting point metal, the low melting point metal melts before the high melting point metal melts, and the molten low melting point metal can corrode the high melting point metal, thereby dissolving the fuse element 3 in a short period of time.

When the fuse element 3 of the protective element 1 melts, the power supply path to the heating element 4 is also cut off, so that the heating element 4 stops generating heat.

Even if an overcurrent exceeding the rated current flows through the battery pack 20, the fuse element 3 of the protective element 1 melts due to self-heating, thereby cutting off the charge/discharge path of the battery pack 20.

In this manner, in the protective element 1, the fuse element 3 melts down due to heat generation caused by energization of the heating element 4 or self-heating of the fuse element 3 caused by an overcurrent. In this case, the protective element 1 has a structure in which a low melting point metal is covered with a high melting point metal, so that deformation of the fuse element 3 can be suppressed when is reflow mounting on the circuit board or when the circuit board on which the protective element 1 is mounted is further exposed to a high-temperature environment such as reflow heating. Therefore, the fluctuation in melting characteristics caused by the fluctuation in resistance value due to the deformation of the fuse element 3 is prevented, and quick melting by a predetermined overcurrent or heat generation from the heating element 4 is possible.

The protective element 1 according to the present invention is not limited to use in a battery pack for a lithium ion rechargeable battery, and can of course be used in various applications that require the interruption of a current path by an electrical signal.

### Second Embodiment

Next, a second embodiment of a protective element to which the present art is applied will be described. In the following description, the same components as those in the above-described protective element 1 will be denoted by the same reference numerals, and detailed description thereof will be omitted.

As illustrated in FIG. 10, in a protective element 50 according to the second embodiment, the length of an end portion protrusion 31a is longer than the length of an intermediate protrusion 31b.

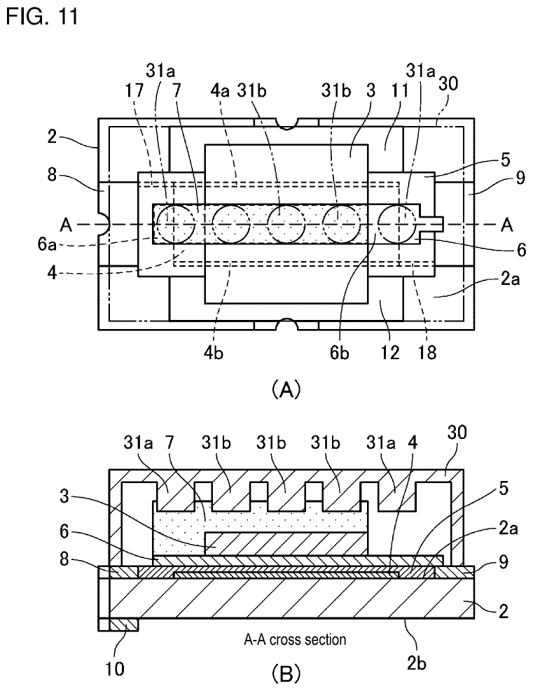

Even when multiple protrusions 31 are provided, if the thickness of the fuse element 3 is changed, if the viscosity of the flux is low, or depending on the spacing between the protrusions 31, the retention force of the flux 7 by the protrusions 31 may be insufficient, and the flux 7 may be biased to one side (see FIG. 11). As a result, the end portion 6a or end portion 6b of the intermediate electrode 6 on the side where the flux 7 is not retained may be oxidized by the heating of the heating element 4, and the molten conductor 3a may not become wet, causing the increased molten conductor 3a of the fuse element 3 to overflow and hinder melt-cutting.

Therefore, in the protective element 50, the length of the end portion protrusion 31a facing the end portion 6a and/or end portion 6b of the intermediate electrode 6 where the flux 7 may be insufficient due to uneven distribution of the flux 7 is made longer than the length of the intermediate protrusion 31b.

As a result, in the protective element 50, the distance between the end portion protrusion 31a and the end portions 6a, 6b of the intermediate electrode 6 is not too large, so that the retention force of the end portion protrusion 31a for the flux 7 can be maintained and uneven distribution can be prevented. Therefore, the flux 7 can be retained across both end portions 6a, 6b of the intermediate electrode 6, preventing a decrease in wettability due to a lack of flux 7, and enabling the fuse element 3 to be cut quickly and reliably.

Here, similarly to the protective element 1, the protective element 50 preferably has a length such that the protrusions 31 (that is, the end portion protrusion 31a and the intermediate protrusion 31b) do not come into contact with the molten fuse element 3. If the protrusions 31 are shortened to avoid contact with the molten conductor 3a of the fuse element 3, the distance between the protrusions 31 and the end portions 6a, 6b of the fuse element 3 and the intermediate electrode 6 increases, reducing the retention of the flux 7. In particular, as illustrated in FIG. 11, the gap between the end portions 6a, 6b of the intermediate electrode 6 on which the fuse element 3 is not mounted and the end portion protrusion 31a widens, which can cause the flux 7 to be unevenly distributed inside the protective element.

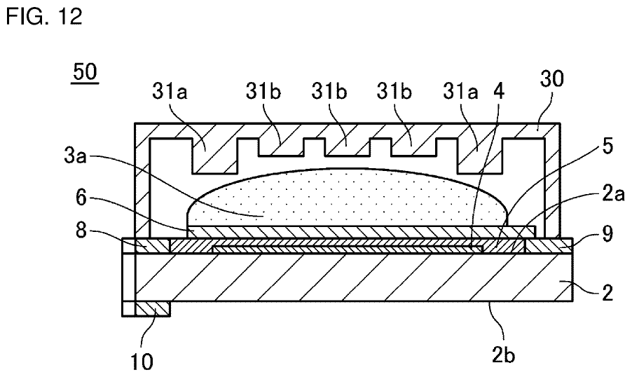

As illustrated in FIG. 12, the molten conductor 3a of the fuse element 3 agglomerated on the intermediate electrode 6 is highest at the center of the intermediate electrode 6 and becomes lower toward the end portions 6a, 6b of the intermediate electrode 6. In the protective element 50, the intermediate protrusion 31b facing the agglomerated molten conductor 3a at the center of the intermediate electrode 6 is short, and contact with the agglomerate of the molten conductor 3a is prevented. Furthermore, the end portion protrusions 31a facing both end portions 6a, 6b of the intermediate electrode 6 are formed long, but the positions at which the end portion protrusions 31a are formed correspond to the portions where the height of the agglomerate of the molten conductor 3a is low. Therefore, by making the length of the end portion protrusions 31a longer than the intermediate protrusions 31b, the protective element 50 maintains the holding force of the flux 7 and prevents uneven distribution, and also prevents heat from being dissipated from the heating element 4 due to contact between the end portion protrusions 31a and intermediate protrusions 31b and the molten conductor 3a, thereby enabling the fuse element 3 to be blown quickly and reliably.

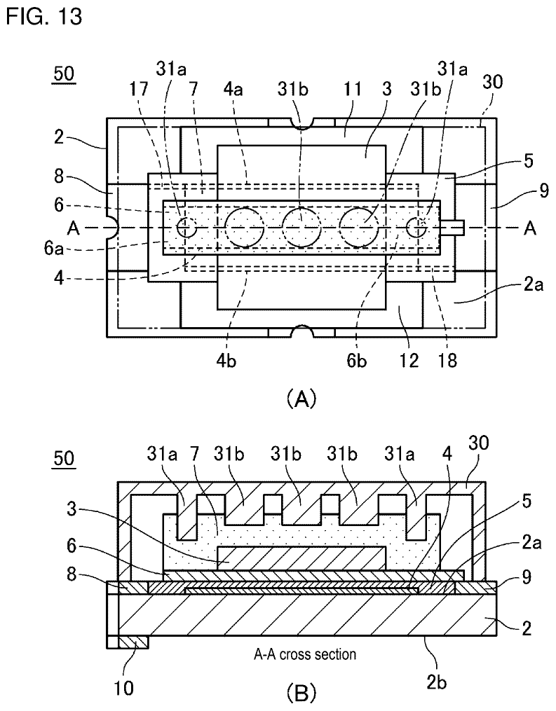

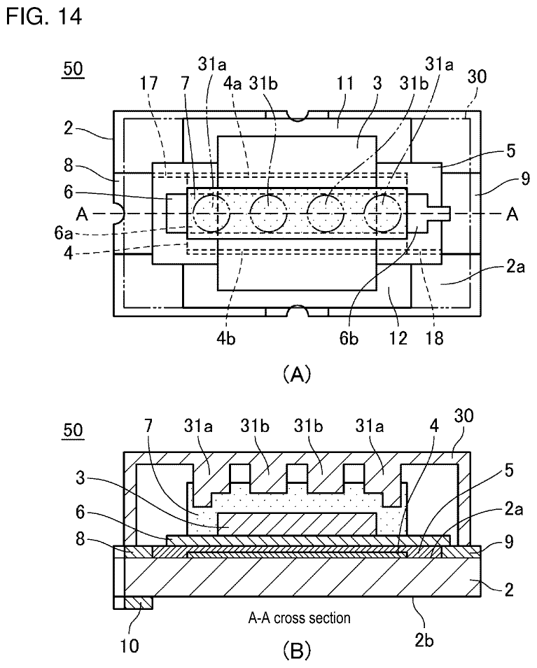

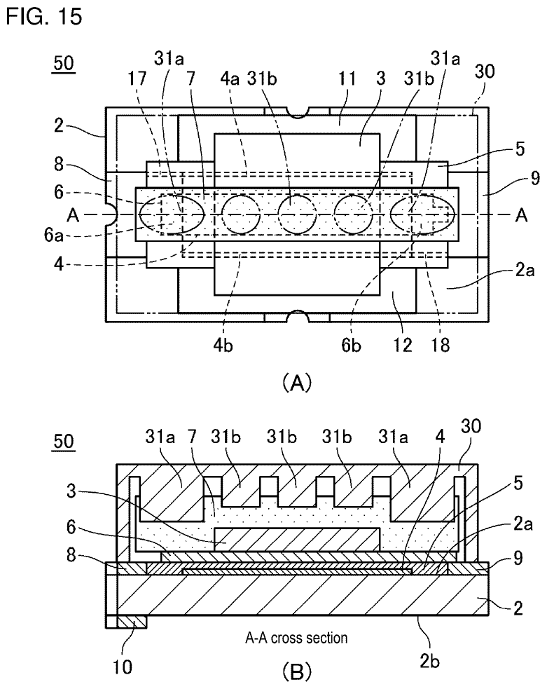

Even in the configuration in which the length of the end portion protrusion 31a is made longer than that of the intermediate protrusion 31b, the end portion protrusion 31a may be formed to have a smaller diameter than the intermediate protrusion 31b, as illustrated in FIG. 13. Furthermore, the end portion protrusion 31a may be erected respectively at a position facing a position where the fuse element 3 of the intermediate electrode 6 is mounted and at a position facing the end portions 6a, 6b where the fuse element 3 is not mounted, and as illustrated in FIG. 14, it may be erected so as to span both positions. In this case, the end portion protrusion 31a may be formed in a stepped shape such that the portion facing the position on the intermediate electrode 6 where the fuse element 3 is mounted is short like the intermediate protrusion 31b, and the portion facing the end portions 6a, 6b of the intermediate electrode 6 is longer than the intermediate protrusion 31b. Furthermore, as illustrated in FIG. 15, the end portion protrusion 31a may be made longer than the intermediate protrusion 31b, and may be configured so as to face the end portions 6a, 6b of the intermediate electrode 6 and have a portion that protrudes from the end portions 6a, 6b. This allows the flux 7 to be held up to a position beyond the ends 6 a and 6 b of the intermediate electrode 6. The end portion protrusion 31a illustrated in FIG. 15 is formed in an elliptical columnar shape having as a major axis a width direction (fusing direction) orthogonal to a current carrying direction of the fuse element 3, but a shape of the end portion protrusion 31a is not limited thereto.

### [Modification 1]

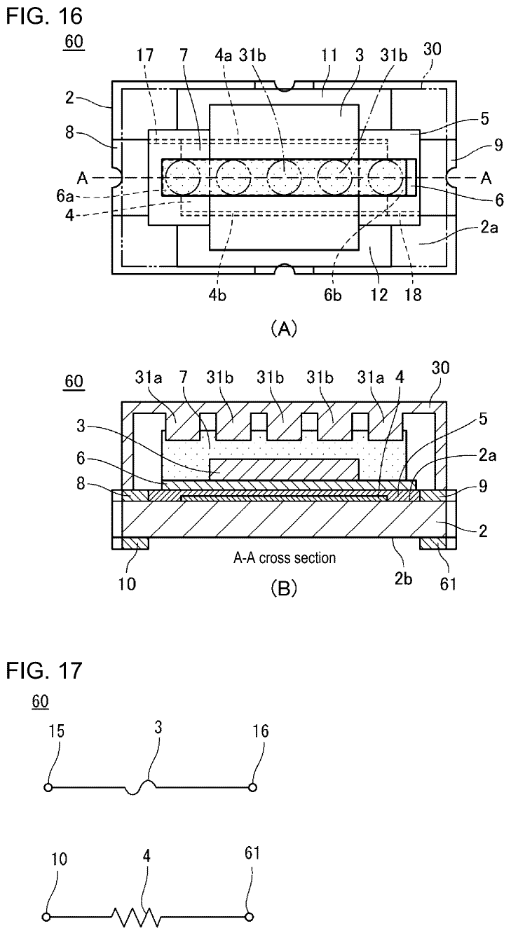

Next, a modified example of a protective element that applies the present art will be described. Note that in the description below, configurations that are the same as those of the above configuration of the protective elements 1 and 50 are labeled with the same reference signs, and details thereof are sometimes omitted. As illustrated in FIGS. 16(A) and (B), the protective element 60 may form a power supply path to the heating element 4 and a current path to the fuse element 3 independently. In the protective element 60 illustrated in FIG. 16, the intermediate electrode 6 and the second heating element electrode 9 are not connected to each other. Similarly to the first heating element electrode 8, the second heating element electrode 9 is connected to a fourth external connection electrode 61 formed on the rear surface 2b of the insulating substrate 2 via a castellation. The heating element 4 is connected to an external power source provided in the external circuit by connecting the third external connection electrode 10 and the fourth external connection electrode 61 to a connection electrode provided in the external circuit board on which the protective element 60 is mounted. The other configuration is the same as that of the protective element 1.

FIG. 17 is a diagram showing a circuit configuration of the protective element 60. The protective element 60 is mounted on an external circuit, whereby the first external connection electrode 15 is connected to the side of the battery stack 25, and the second external connection electrode 16 is connected to the side of the positive electrode terminal 20a, and thereby the fuse element 3 is connected in series on the charge/discharge path of the battery stack 25. The heating element 4 is connected to the current control element 28 via the first heating element electrode 8 and the third external connection electrode 10, and is connected to the battery stack 25. Moreover, the heating element 4 is connected to a ground that is not illustrated, via the second heating element electrode 9 and the fourth external connection electrode 61. This forms a power supply path to the heating element 4, the current supply of which can be controlled by the current control element 28. When the fuse element 3 melts, the protective element 60 detects this and causes the detection circuit 27 and the current control element 28 to stop the flow of electricity to the heating element 4.

The protective element 60 has the protrusions 31 formed thereon, similar to the protective elements 1 and 50, and the flux 7 is retained in a predetermined position by the protrusions 31, thereby achieving the same functions and effects as the protective elements 1 and 50.

### [Modification 2]

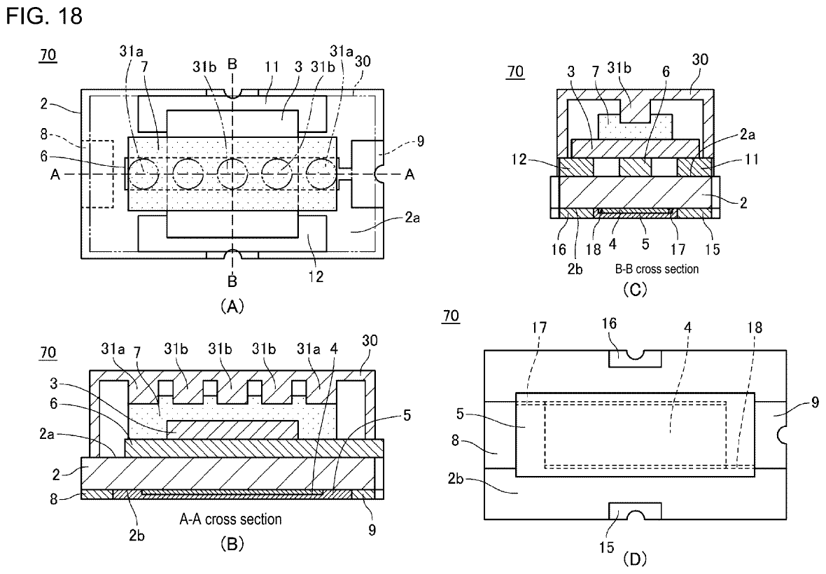

Next, a second modified example of a protective element where the present art is applied will be described. Note that in the description below, configurations identical to those of the protective elements 1, 50, and 60 described above are sometimes labeled with the same reference signs and the details thereof are omitted. FIG. 18 shows a protective element 70 relating to a modified example, where (A) is a plan view showing the cap member omitted, (B) is a cross-sectional view taken along line A-A in (A), (C) is a cross-sectional view taken along line B-B in (A), and (D) is a bottom view.

As illustrated in FIG. 18(A) to (D), in the protective element 70 of the second modified example, a heating element 4, first and second extraction electrodes 17, 18, and an insulating layer 5 covering these are formed on the rear surface 2b opposite the front surface 2a of the insulating substrate 2. Further, on the rear surface 2b of the insulating substrate 2, first and second heating element electrodes 8, 9 and first and second external connection electrodes 15, 16 are formed.

Furthermore, first and second electrodes 11, 12 and an intermediate electrode 6 are formed on a front surface 2a of the insulating substrate 2, and the fuse element 3 is mounted on each of these electrodes 11, 12, 6.

The first and second electrodes 11, 12 and intermediate electrode 6 provided on the front surface 2a of the insulating substrate 2, as well as the heating element 4, first and second extraction electrodes 17, 18, first and second heating element electrodes 8, 9, and first and second external connection electrodes 15, 16 provided on the rear surface 2b of the insulating substrate 2, can be formed by a process similar to that of the protective element 1 described above.

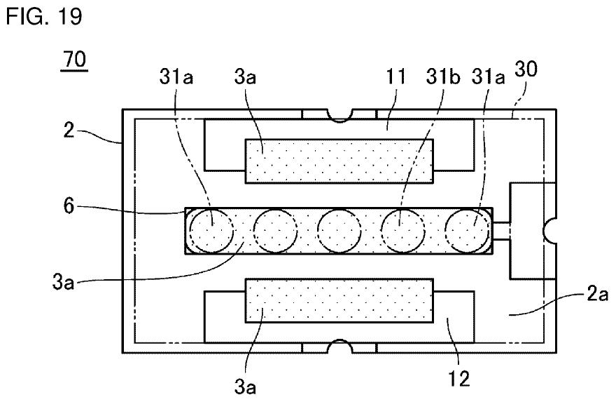

The second heating element electrode 9 and the intermediate electrode 6 are electrically connected by castellations formed on the side surface of the insulating substrate 2 or conductive through holes passing through the insulating substrate 2. That is, the intermediate electrode 6 is electrically and thermally connected to the heating element 4 via the second heating element electrode 9. As a result, in the protective element 70, the heating element 4 heats the intermediate electrode 6 via the insulating substrate 2, and the heat from the heating element 4 is transferred to the intermediate electrode 6 via the second heating element electrode 9, which has excellent thermal conductivity, and the castellation, thereby heating and melting the fuse element 3 (FIG. 19).

In addition, in the protective element 70, the first and second heating element electrodes 8, 9 also serve as external connection electrodes connected to electrodes of an external circuit board, so the third external connection electrode 10 provided on the protective element 1 and the fourth external connection electrode 61 provided on the protective element 60 are not provided.

The protective element 70 has a protrusion 31 formed similarly to the protective elements 1, 50, and 60, and the flux 7 is retained at a predetermined position by the protrusion 31, thereby exhibiting the same operation and effect as the protective elements 1, 50, and 60.

In addition, in the protective element 70, similar to the protective element 60, the intermediate electrode 6 and the second heating element electrode 9 may be disconnected, so that the power supply path to the heating element 4 and the current path of the fuse element 3 are formed independently.

### EXAMPLES

### First Example

An example of the present art will next be described. In the first example, samples of the protective element were produced with different numbers of protrusions, and a power of 33 W was applied to the heating element to perform a meltdown test of the fuse element.

The protective element samples according to the example and comparative example have the same configuration as the protective element 1 described above, except for the number of protrusions provided on the cap member. In addition, a fuse element having a thickness of 100 μm was used for each sample. Then, a mask having openings corresponding to the areas to which the flux was to be applied in the protective elements of the example and comparative example was used to apply a predetermined amount of flux to a predetermined area.

For the protective elements according to the examples and the comparative examples, the average fusing time (seconds), the minimum and maximum fusing times (seconds), and the uncut incidence rate (%) were obtained. The number of samples, n, is 192 for both the protective elements according to the embodiment and the comparative example. The “uncut incidence rate (%)” refers to the rate of occurrence of samples in which the fuse element does not melt even after a specified time has elapsed, and occurs when the fuse element or intermediate electrode is oxidized, preventing melting and making it impossible to cut the fuse.

### Example 1

In Example 1, four cylindrical protrusions of the same size were formed on the top surface of the cap member in a row along the intermediate electrode. The end portion protrusions on both end portions are erected so as to extend over both the position facing the position on the intermediate electrode where the fuse element is mounted and the position facing the end where no fuse element is mounted (see FIG. 3). The flux is applied and retained on the fuse element and on both end portion sides of the intermediate electrode that protrude from the fuse element, depending on the positions where the protrusions are formed.

### Example 2

Example 2 formed five columnar protrusions in a row along the intermediate electrode on the top surface of the cap member that have the same dimensions. The protrusions are erected respectively at positions facing the position where the fuse element of the intermediate electrode is mounted and at positions facing the end portion where the fuse element is not mounted (see FIG. 1). The flux is applied over the fuse element and over the entire area of both end portions of the intermediate electrode that protrude from the fuse element, depending on the positions of the protrusions, and is retained from over the fuse element to the tips of the end portions of the intermediate electrode.

### Comparative Example 1

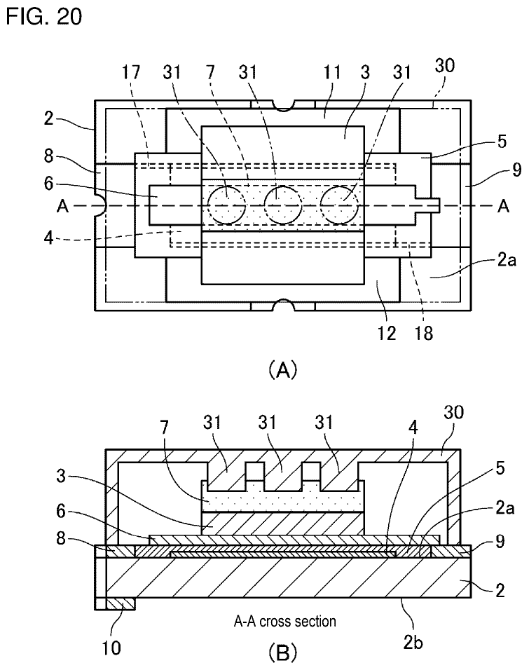

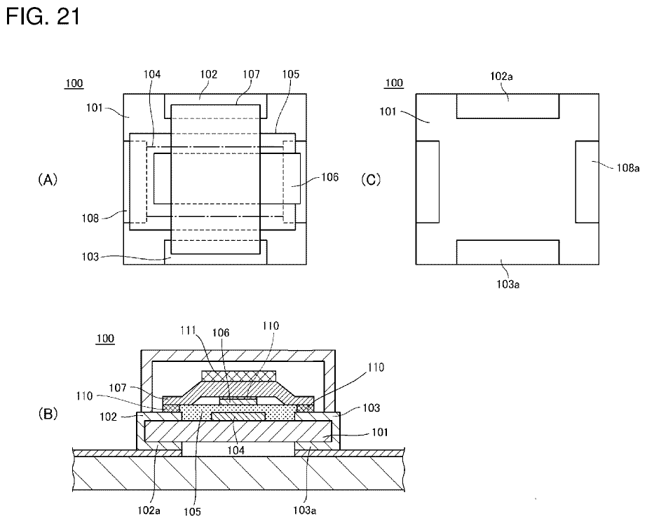

In the protective element according to Comparative Example 1, as illustrated in FIG. 20, three cylindrical protrusions of the same size were formed on the top surface of the cap member in a row along the intermediate electrode. The protrusion is provided only at a position facing the position on the intermediate electrode where the fuse element is mounted. The flux is applied and retained only on the fuse element 3 according to the positions where the protrusions are formed.

TABLE 1

| | | | | Comparative |
|---|---|---|---|---|
| | | Example 1 | Example 2 | Example 1 |
| Number of protrusions | | 4 | 5 | 3 |
| Fusing time | Maximum | 2.7 | 1.7 | 8.1 |
| (seconds) | Minimum | 2.2 | 1.3 | 5.3 |
| | Average | 1.7 | 1.5 | 3.2 |

| | | | |
|---|---|---|---|
| Uncut incidence rate (%) | 8 | 0 | 25 |

As illustrated in Table 1, in the protective elements of Examples 1 and 2, by providing protrusions at positions facing the end portions of the intermediate electrode protruding from the fuse element, the flux could be applied and maintained all the way to both end portions of the intermediate electrode, and good results were achieved in terms of the fusing time and the uncut incidence rate.

In Comparative Example 1, the protrusions are provided only at positions facing the fuse element, and no flux is retained at either end portion of the intermediate electrode. For this reason, the amount of flux applied was relatively low, and the heating of the heating element caused oxidation of both end portions of the fuse element and the intermediate electrode, lengthening the fusing time and increasing the uncut incidence rate.

In addition, to compare Example 1 and Example 2, Example 2, in which the number of protrusions and the amount of flux applied were large and the flux was applied and maintained up to the end portion of the intermediate electrode, showed relatively favorable results in terms of the fusing time and the rate of uncut incidence rate.

### Second Example

A second example of the present invention will next be described. In the second embodiment, a sample of the protective element with the length of the protrusion changed was produced, 33 W of power was applied to the heating element, and a fusing test of the fuse element was performed.

The protective element samples according to the embodiments and the comparative examples have the same configuration as the protective element 1 described above, except for the length of the protrusions provided on the cap member. Furthermore, a fuse element with a thickness of 125 μm was used for each sample. Then, a mask having openings corresponding to the areas to which the flux was to be applied in the protective elements of the example and comparative example was used to apply a predetermined amount of flux to a predetermined area.

### Example 3

Example 3 has five cylindrical protrusions formed in a row along the intermediate electrode on the top surface of the cap member. The intermediate protrusion formed at the position facing the position where the fuse element is mounted is shorter than the end portion protrusion formed at the position facing the end of the intermediate electrode where the fuse element is not mounted (see FIG. 10). The distance between the end portion protrusion and the end of the intermediate electrode was set to a distance that would allow flux to be retained therebetween (approximately 350 μm or less), and the distance between the intermediate protrusion and the fuse element was set to a distance that would not allow contact with the molten conductor of the fuse element (approximately 100 μm or more).

### Comparative Example 2

Comparative Example 2 had the same structure as Example 3, except that five cylindrical protrusions of the same size were formed on the top surface of the cap member in a row along the intermediate electrode (see FIG. 1). The distance between each end portion protrusion and the end of the intermediate electrode was set to a distance (approximately 350 μm or less) that would allow flux to be retained therebetween.

### Comparative Example 3

Comparative Example 3 was made to have the same configuration as working example 3 (see FIG. 11) with the exception of five cylindrical protrusions of the same dimension formed in a row along the intermediate electrode on the top surface of the cap member. Each protrusion was spaced at a distance (approximately 100 μm or more) such that it would not come into contact with the molten conductor of the fuse element.

TABLE 2

| | | | Comparative | Comparative |
|---|---|---|---|---|
| | | Example 1 | Example 2 | Example 3 |
| Number of protrusions | | 5 | 5 | 5 |
| Uneven flux | | No | No | Yes |
| Fusing time | Maximum | 4.5 | 6.2 | 9.0 |
| (seconds) | Minimum | 3.1 | 2.6 | 4.7 |
| | Average | 2.6 | 4.1 | 3.0 |

| | | | |
|---|---|---|---|
| Uncut incidence rate (%) | 0 | 2 | 4 |

As illustrated in Table 2, in Example 3, the end portion protrusions were made long enough to hold flux between them and the end portions of the intermediate electrode, so that the flux was applied onto the fuse element and to both end portions of the intermediate electrode that protruded from the fuse element, preventing oxidation of the intermediate electrode and allowing the molten conductor to be sufficiently retained over both end portions. In addition, since the intermediate protrusion does not come into contact with the molten fuse element 3, heat absorption by the protrusion and cap member is prevented, and good results were obtained in terms of fusing time and uncut incidence rate.

In Comparative Example 2, the end portion protrusions were formed to a length sufficient to hold flux between the end portions of the intermediate electrode, and the distance between the intermediate protrusions and the fuse element was shortened (less than approximately 100 μm); as a result, the melted fuse element hit the intermediate protrusion, and the heat from the heating element was dissipated to the cap member, lowering the temperature of the fuse element, lengthening the fusing time, and increasing the uncut incidence rate. This shows that if the distance between the protrusion and the fuse element is shortened by making the fuse element thicker, there is a risk that the molten conductor of the fuse element will come into contact with the intermediate protrusion, and therefore it is necessary to ensure a distance (at least 100 μm or more) according to the volume (melt amount) of the fuse element.

In Comparative Example 3, the length of all the erected protrusions was shortened, so that the flux retention strength was reduced and the flux became unevenly distributed. As a result, one end portion of the intermediate electrode was oxidized by the heating of the heating element, which reduced the capacity of the molten conductor, lengthened the fusing time, and increased the uncut incidence rate.

### DESCRIPTION OF REFERENTIAL NUMERALS AND CODES

1 protective element, 2 insulating substrate, 2a front surface, 2b rear surface, 3 fuse element, 3a molten conductor, 4 heating element, 5 insulating layer, 6 intermediate electrode, 6a one end portion, 6b other end portion, 7 flux, 8 first heating element electrode, 9 second heating element electrode, 10 third external connection electrode, 11 first electrode, 12 second electrode, 13 low melting point metal, 14 high melting point metal, 15 first external connection electrode, 16 second external connection electrode, 17 first extraction electrode, 18 second extraction electrode, 20 battery pack, 21 battery cell, 22 charging device, 23 current control element, 24 control unit, 25 battery stack, 26 charge/discharge control circuit, 27 detection circuit, 28 current control element, 30 cap member, 31 protrusion, 31a end portion protrusion, 31b intermediate protrusion, 35 connecting body, 36 mask, 37 opening, 38 squeegee, 50 protective element, 60 protective element, 61 fourth external connection electrode, 70 protective element

1. A protective element comprising:
an insulating substrate;
a heating element provided on a front surface side of the insulating substrate;
an insulating layer covering the heating element;
an intermediate electrode provided on the insulating layer;
a fuse element mounted on the intermediate electrode;
a cap member covering the front surface of the insulating substrate; and
a flux, wherein:
the cap member comprises at least one protrusion that retains the flux in a predetermined position and is provided vertically, facing the intermediate electrode;
the intermediate electrode has a length that is longer than a width of the fuse element in a direction orthogonal to a current flow direction of the fuse element, and at least one end portion thereof extends beyond the fuse element; and
the at least one protrusion is provided at a position facing the fuse element which is mounted on the intermediate electrode and at a position facing the at least one end portion of the intermediate electrode at which the fuse element is not mounted, and retains the flux on the fuse element and at the end portion.

2. The protective element according to claim 1, wherein each of the at least one protrusion has a length which does not come into contact with a melted fuse element in a state in which the fused element is fused.

3. The protective element according to claim 1, wherein a length of the protrusion provided at the position facing the end portion of the intermediate electrode is longer than a length of the protrusion provided at the position facing the fuse element.

4. The protective element according to claim 1, wherein both end portions of the intermediate electrode extend beyond the fuse element in the direction orthogonal to the current flow direction of the fuse element, and protrusions are provided at positions facing both of the end portions.

5. The protective element according to claim 1, wherein the protrusion is provided symmetrically in the direction orthogonal to the current flow direction of the fuse element.

6. A protective element comprising:
an insulating substrate;
an intermediate electrode provided on a front surface side of the insulating substrate;
a fuse element mounted on the intermediate electrode;
a cap member covering the front surface of the insulating substrate;
a flux;
a heating element provided on a rear surface side opposite the front surface of the insulating substrate; and
an insulating layer covering the heating element, wherein:
the cap member comprises at least one protrusion that retains the flux in a predetermined position and is provided vertically, facing the intermediate electrode;
the intermediate electrode has a length that is longer than a width of the fuse element in a direction orthogonal to a current flow direction of the fuse element, and at least one end portion thereof extends beyond the fuse element; and
the at least one protrusion is provided at a position facing the fuse element which is mounted on the intermediate electrode and at a position facing the at least one end portion of the intermediate electrode at which the fuse element is not mounted, and retains the flux on the fuse element and at the end portion.

7. A method of manufacturing a protective element, comprising:
forming a connecting body comprising: an insulating substrate; a heating element provided on a front surface side of the insulating substrate; an insulating layer covering the heating element; an intermediate electrode provided on the insulating layer; and a fuse element mounted on the intermediate electrode;
coating the fuse element and the intermediate electrode with a flux via a mask having an opening corresponding to a coating region; and
connecting a cap member to the front surface of the insulating substrate on which the fuse element is mounted to cover the front surface of the substrate, wherein:
the cap member comprises at least one protrusion that retains the flux in a predetermined position and is provided vertically, facing the intermediate electrode;
the intermediate electrode has a length that is longer than a width of the fuse element in a direction orthogonal to a current flow direction of the fuse element, and at least one end portion thereof extends beyond the fuse element; and
the at least one protrusion is provided at a position facing the fuse element which is mounted on the intermediate electrode and at a position facing the at least one end portion of the intermediate electrode at which the fuse element is not mounted, and retains the flux on the fuse element and at the end portion.

8. A method of manufacturing the protective element according to claim 6, comprising:
forming a connecting body comprising: an insulating substrate; an intermediate electrode provided on a front surface side of the insulating substrate; a heating element provided on a rear surface opposite the front surface of the insulating substrate; an insulating layer covering the heating element; and a fuse element mounted on the intermediate electrode;
coating the fuse element and the intermediate electrode with a flux via a mask having an opening corresponding to a coating region; and
connecting a cap member to the front surface of the insulating substrate on which the fuse element is mounted to cover the front surface of the substrate, wherein:
the cap member comprises at least one protrusion that retains the flux in a predetermined position and is provided vertically, facing the intermediate electrode;
the intermediate electrode has a length that is longer than a width of the fuse element in a direction orthogonal to a current flow direction of the fuse element, and at least one end portion thereof extends beyond the fuse element; and
the at least one protrusion is provided at a position facing the fuse element which is mounted on the intermediate electrode and at a position facing the at least one end portion of the intermediate electrode at which the fuse element is not mounted, and retains the flux on the fuse element and at the end portion.

9. The protective element according to claim 2, wherein a length of the protrusion provided at the position facing the end portion of the intermediate electrode is longer than a length of the protrusion provided at the position facing the fuse element.

10. The protective element according to claim 2, wherein both end portions of the intermediate electrode extend beyond the fuse element in the direction orthogonal to the current flow direction of the fuse element, and protrusions are provided at positions facing both of the end portions.

11. The protective element according to claim 2, wherein the protrusion is provided symmetrically in the direction orthogonal to the current flow direction of the fuse element.

12. The protective element according to claim 6, wherein each of the at least one protrusion has a length which does not come into contact with a melted fuse element in a state in which the fused element is fused.

13. The protective element according to claim 6, wherein a length of the protrusion provided at the position facing the end portion of the intermediate electrode is longer than a length of the protrusion provided at the position facing the fuse element.

14. The protective element according to claim 6, wherein both end portions of the intermediate electrode extend beyond the fuse element in the direction orthogonal to the current flow direction of the fuse element, and protrusions are provided at positions facing both of the end portions.

15. The protective element according to claim 6, wherein the protrusion is provided symmetrically in the direction orthogonal to the current flow direction of the fuse element.

16. The protective element according to claim 12, wherein a length of the protrusion provided at the position facing the end portion of the intermediate electrode is longer than a length of the protrusion provided at the position facing the fuse element.

17. The protective element according to claim 12, wherein both end portions of the intermediate electrode extend beyond the fuse element in the direction orthogonal to the current flow direction of the fuse element, and protrusions are provided at positions facing both of the end portions.

18. The protective element according to claim 12, wherein the protrusion is provided symmetrically in the direction orthogonal to the current flow direction of the fuse element.
